(19) United States
(12) Patent Application Publication
(10) Pub. No.: US 2016/0031143 A1
(43) Pub. Date: Feb. 4, 2016

(54) ROTARY TOOL EJECTION TECHNOLOGY

(71) Applicant: Weidenmiller Company, Itasca, IL (US)

(72) Inventors: STEPHEN J KRAS, Chicago, IL (US); Rich Paul Budek, Elmhurst, IL (US)

(21) Appl. No.: 14/810,833

(22) Filed: Jul. 28, 2015

Related U.S. Application Data
(60) Provisional application No. 62/030,576, filed on Jul. 29, 2014.
(60) Provisional application No. 62/030,587, filed on Jul. 29, 2014.

(51) Int. Cl. B29C 47/00; A23P 1/12

(52) U.S. Cl. CPC B29C 47/0066; A23P 1/12; B29L 2031/00

(57) ABSTRACT

A rotary die ejection technology is disclosed. A cylindrical die roll has a rotary cylinder having internal air and regulation channels. The outer surface of the rotary cylinder includes mold cavity or cutter cavity. The cavity may be in the form of a socket capable of receiving inserts, including plugs and tool inserts. The plugs and tool inserts may be partially or entirely constructed from a porous material. The mold cavity or cutter cavity is in fluid communication with the internal air channel.

### RELATED APPLICATIONS

The present patent document claims the benefit of the filing date under 35 U.S.C. §119(e) of Provisional U.S. Patent Application Ser. No. 62/030,576, filed Jul. 29, 2014, and Provisional U.S. Patent Application Ser. No. 62/030,587, filed Jul. 29, 2014, each of which is hereby incorporated by reference in its entirety, including all drawings and documents filed therewith.

### BACKGROUND

Consumers increasingly rely upon the convenience of packaged food products. Convenience foods for both animals and humans have proliferated—and range from healthy to indulgent. Consumables such as but not limited to cookies, candies, crackers, and animal nourishment, come in a variety of textures, compositions, shapes, and sizes. Rotary die cutters and rotary die molds are a popular method of forming consumable food products.

### BRIEF SUMMARY

A rotary die ejection technology is disclosed. A cylindrical die roll has an rotary cylinder having internal air and regulation channels. The outer surface of the rotary cylinder includes sockets capable of receiving tool inserts. The tool inserts being partially or entirely constructed from a porous material. The assembly of the tool insert with the socket creating a mold cavity or cutter cavity. The mold cavity or cutter cavity is in fluid communication with the internal air channel.

Other features and advantages of the disclosure will be, or will become, apparent to one of skill in the art upon examination of the following figures and detailed description. It is intended that all such additional advantages and features be included in the description, be within the scope of the invention, and be protected by the claims.

### BRIEF DESCRIPTION OF THE DRAWINGS

FIG. 1 is a perspective view of a first rotary tool;

FIG. 2 is a cross section view of a first rotary tool;

FIG. 3 is a second cross section view of a first rotary tool;

FIG. 4 is a third cross section view of a first rotary tool;

FIG. 5 is a fourth cross section view of a first rotary tool;

FIG. 6 is a view of an air supply hub;

FIG. 7 is a perspective view of a second rotary tool;

FIG. 8 is a view of a docker pin plug;

FIG. 9 is a cross section view of a second rotary tool;

FIG. 10 is a second cross section view of a second rotary tool;

FIG. 11 is a view of a plug;

FIG. 12 is a view of a plug;

FIG. 13 is a view of a consumable;

FIG. 14 is a view of a second consumable;

FIG. 15 is a view of a third rotary tool;

FIG. 16 is a cross section view of a third rotary tool;

FIG. 17 is an exploded assembly view of a third rotary tool;

FIG. 18 is a view of a fourth rotary tool;

FIG. 19 is a cross section view of a fourth rotary tool; and

FIG. 20 is an exploded assembly view of a fourth rotary tool in cross section.

### DETAILED DESCRIPTION OF THE DRAWINGS

Food products of various kinds, including cookies, crackers, candies, animal consumables, and other products, are frequently formed by high-volume automated rotary mold and/or rotary cutting devices. A rotary die is a cylinder, the surface of which is covered with shallow engraved cavities. A rotary cutter is a cylinder, the surface of which is covered with portions that rise about the face of the cylinder. Hybrid forms may also exist which include both engraved cavities and raised portions. In one exemplary process, the cylinder rotates past the opening in a hopper filled with food product (e.g., a food dough). The food product fills any engraved portions on the cylinder. Excess dough is sheared off from the main mass by a blade. As the cylinder continues to rotate, the dough pieces are ejected onto a conveyor belt.

In another exemplary process, rotary die cutting uses a cylindrical die on a rotary press. A long sheet or web of material is few through the rotary press into an area which holds a rotary tool, for example but not limited to, a rotary die cutter or a rotary die mold. The rotary tool may cut out shapes, make perforations or creases, impart aesthetic design, and/or cut the sheet or web into smaller parts. Rotary die cutting allows for the manufacture of multiple substantially identical formed products.

Several processes are used to release the formed product from the rotary tool. Some use fat and lard as lubricants to discourage attachment of the food product to the rotary tool. With the rising popularity of fat-free products, the industry increasingly adopted rotary tool coatings to assist release of formed shapes. Examples of rotary tool coatings include formulations of TEFLON and ceramics that are FDA and USDA approved for food contact.

Many known coatings wear out from repeated use; therefore the rotary tools require routine maintenance. As the rotary tool coatings wear out, the release fidelity decreases. Product increasingly sticks to the surface of the rotary tool. Decreases in fidelity result in considerable expense due to lost food product (e.g., through deformations, and sticking), down time, and loss of efficiency. Furthermore, the maintenance process results in downtime. Maintenance requires removing the subject machine from operation while the rotary tool is removed for reconditioning. The reconditioning process takes several days to several weeks and bears a significant expense. In an attempt to realize a large product output despite the maintenance inefficiencies, many companies are required to run several machine lines so that they can rotate production and maintenance. This requires larger more expensive facilities to house redundant machinery.

We disclose a rotary tool ejection technology that is capable of operating at high efficiency with minimal maintenance. In one variation, the rotary tool ejection technology eliminates the requirement of rotary tool coatings. In a variation, the rotary tool ejection technology eliminates the requirement of the use of lubricants, including by increasing the fat content of the food product. In a variation, the rotary tool ejection technology features a rotary tool with no internal moving parts, further reducing maintenance concerns. The reduction of moving parts further increases the sanitation of the system, as moving parts often create additional surfaces in which food product may be trapped.

We also disclose a novel method of employing a porous material within the rotary tool system. In one variation, the porous material may be a porous metal material that has inter-connected porosity. A porous metal material may be fabricated from metal powder particles using powder metallurgy techniques. The porous material may have a range of pore sizes from about 0.5 micrometer to about 200 micrometers.

### DEFINITIONS

Definitions: unless stated to the contrary, for the purpose of the present disclosure the following terms shall have the following definitions:

A reference to “another variation” in describing an example does not imply that the referenced variation is mutually exclusive with another variation unless expressly specified.

The terms “a,” “an” and “the” mean “one or more,” unless expressly specified otherwise.

The phrase “at least one of” when modifying a plurality of things (such as an enumerate list of things) means any combination of one or more of those things, unless expressly specified otherwise.

The term “represent” and like terms are not exclusive, unless expressly specified otherwise. For example, the term “represents” does not mean “represents only,” unless expressly specified.

The term “e.g.” and like terms means “for example, but not limited to” and thus does not limit the term or phrase it explains.

The term “porous material” refers to a material that has inter-connected porosity. A porous material may be fabricated from metal powder particles using powder metallurgy techniques. The porous material may comprise synthetic materials, ceramics, or combinations and composites thereof. The porous material may be a sintered material or may be a micro-drilled material. The porous material may have a range of pore sizes (whether created by a sintering process or by micro-drilling) from about 0.05 micrometer to about 300 micrometers. For example, the porous material may have a pore size in the range in micrometers of about 0.05-300, 0.5-300, 0.2-100, 5.0-30, 20-40, or any individual value or range falling in between the listed ranges. Additionally or alternatively, the pore size within a porous material may vary throughout the material or the porous material may include pores of more than one pore size within the disclosed ranges. A porous insert is an insert, which may be a plug, a machined insert, or otherwise that is made of porous material and machined to be fit and/or retained in a mold cavity or socket.

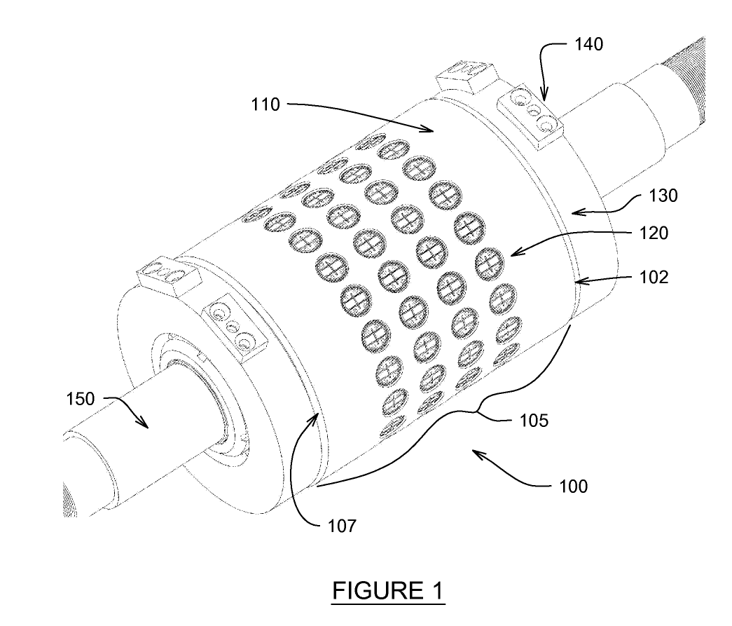

FIG. 1. A rotary tool 100 may include a rotary cylinder 105, one or more air supply hub 130 and a central shaft 150. The rotary cylinder 105 and the air supply hub 130 may be assembled on the central shaft 150. The central shaft 150 may adapt the rotary tool 100 to placement into any rotary manufacturing system. The supply of ejection air is attached to the rotary tool by the air supply hub 130. The air supply hub 130 supplies air to the rotary tool as described in more detail throughout.

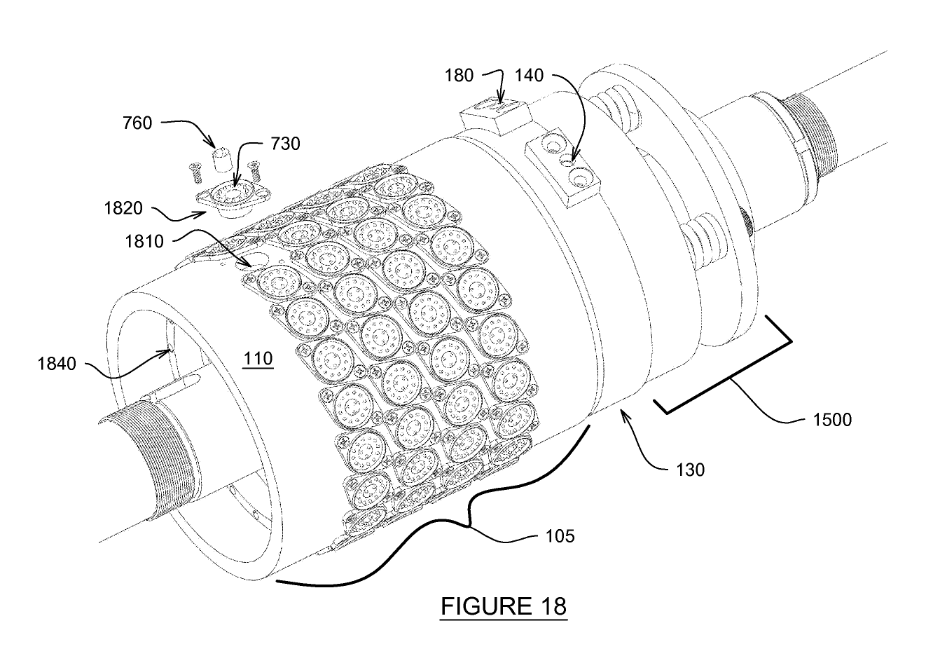

The rotary cylinder 105 may have a first end 102, a second end 107, and a surface face 110. The first end 102 may be parallel to the second end 107. The surface face 110 may be the exterior portion of the rotary tool 100. The surface face 110 may be the face of the rotary tool that comes into contact with a product dough. The surface face 110 may include a mold cavity 120. FIG. 1 provides an exemplary illustration of a rotary tool having mold cavities 120 arranged on the surface face 110. The mold cavities 120 are shown in sets of four, however, the rotary tool 100 may include fewer or more mold cavities 120 per set. Additional or alternative arrangements may include offset pitching and nesting of mold cavities 120, among others. Other arrangements are also possible. While mold cavities 120 are shown, the system may additionally or alternatively include cutters and/or sockets (e.g., examples provided at FIG. 18).

The rotary cylinder 105 may be a one-piece construction or a multi-piece construction. The rotary cylinder 105 may be made of a non-porous material, e.g., non-porous brass, steel, metal or the rotary cylinder 105 may be made of a porous metal material.

A rotary tool 100 may include an air ejection technology. The rotary tool 100 may include an internal manifold for circulating air (shown in subsequent figures) supplied, for example, through an air port 140. The rotary tool 100 may include one or more air supply hub(s) 130. In the example of FIG. 1, the rotary tool 100 is assembled adjacent to two air supply hubs 130. Where two air supply hubs 130 are present, the air supply hub(s) 130 may be arranged in a book-end type arrangement with the rotary cylinder 105. The air supply hub 130 may include one or more air ports 140. The air ports 140 may be points of air entry and/or air exit.

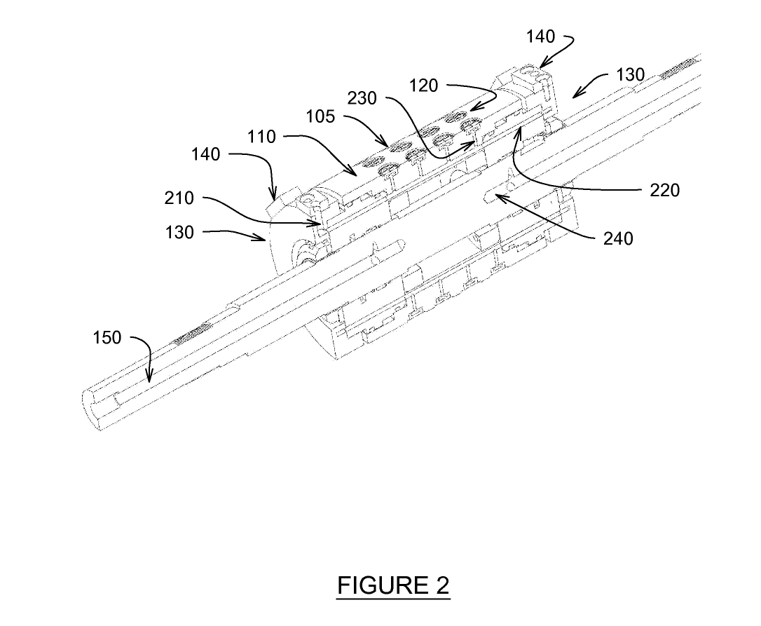

FIG. 2 provides a cross-section view of the rotary tool 100 of FIG. 1, cut through the plane of channels 210 and 220 and orifice 230.

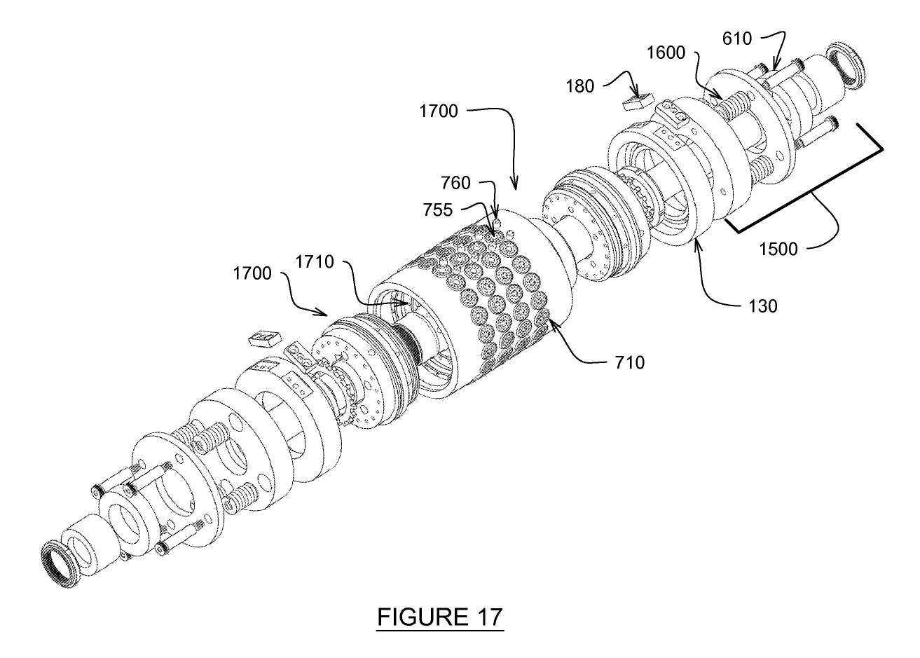

The rotary tool 100 may include one or more channels. The one or more channels may accommodate the circulation of ejection air, temperature regulating fluid, or otherwise, e.g., through the rotary cylinder 105. FIG. 2 provides a cross section of an exemplary system of air channels. In this figure, a source channel 210, which may be located on an air supply hub 130, provides ejection air to a distribution channel 220. The distribution channel 220 may enter the rotary cylinder 105 at one or more of the first end 102 and the second end 107. (FIG. 17 provides a view of the distribution channel opening 1710 through which the distribution channel 220 enters the rotary cylinder.) The distribution channel 220 may pass through the rotary cylinder 105 as a longitudinal channel parallel to a row of mold cavities 120. Each mold cavity 120 is in fluid communication with the distribution channel 220, e.g., through an orifice 230. The mold cavity 120 may include a porous material region, which may permit the passage of air from the distribution channel 220 and the orifice 230 to contact and act upon the contents of the mold cavity 120, e.g., product dough.

Air supply to the distribution channels 220 may be regulated or unregulated. In one example, supply of air to the distribution channels 220 may be supplied in a periodic pattern, e.g., corresponding to a preferred product ejection position of the rotary tool 100. Air may be supplied to the distribution channels 220 located in the rotary cylinder by the air supply hub 130. The distribution channels 220 may supply air to the orifices 230, e.g., creating an ejection force on material in the mold cavity 120.

The mold cavity 120 may include a region of porous material. The porous material may be permissive to air flow, e.g., allowing air to pass from the distribution channel 220 through the mold cavity 120.

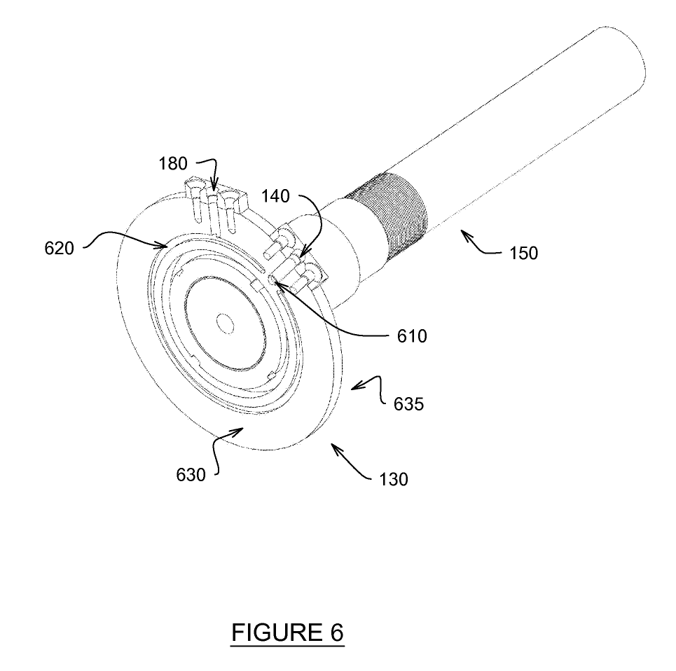

In another example, the assembly of the rotary cylinder 105 with the air supply hubs 130 may allow for regulation of air flow into the distribution channels 220. For example, the air supply hubs 130 may be stationary relative to the rotary cylinder 105. As the rotary cylinder 105 rotates relative to the air supply hub 130, each row of mold cavities 120 may receive a pulse of ejection air (e.g., from the port FIG. 6, 610 of the air supply hub 130). The pulse of ejection air may be timed with the timing of other elements of the system, e.g., conveyor systems. Timing of the air ejection through the mold cavities 120 may be set by the selective positioning of the air supply hub 130 relative to the distribution channel 220. For example, when the rotary cylinder 105 rotates such that a distribution channel 220 of the rotary cylinder 105 is aligned with the distribution channel 220 of the air supply hub 130, air will pass into the distribution channel 220 of the rotary cylinder 105. Air ejection may thus occur on a row by row basis.

The air supply hub 130 may be constructed of any suitable material. In a variation, the air supply hub 130 may be constructed of a bearing type material such as PTFE (Teflon) to permit sliding and sealing on the end surfaces of the rotary cylinder 105.

FIG. 2 also provides a cross section of a portion of an exemplary temperature control system. The temperature control system may include a source channel 240. The source channel 240 may be located within the shaft 150. The temperature control circuit may circulate a fluid, for example a fluid capable of being heated or cooled. The fluid may have the property of heating and/or cooling a surface of the rotary tool 100. The fluid may have the property of maintaining a temperature of the rotary tool 100. The heating, cooling, and/or maintenance of a temperature may optimize ejection from the mold cavities 120.

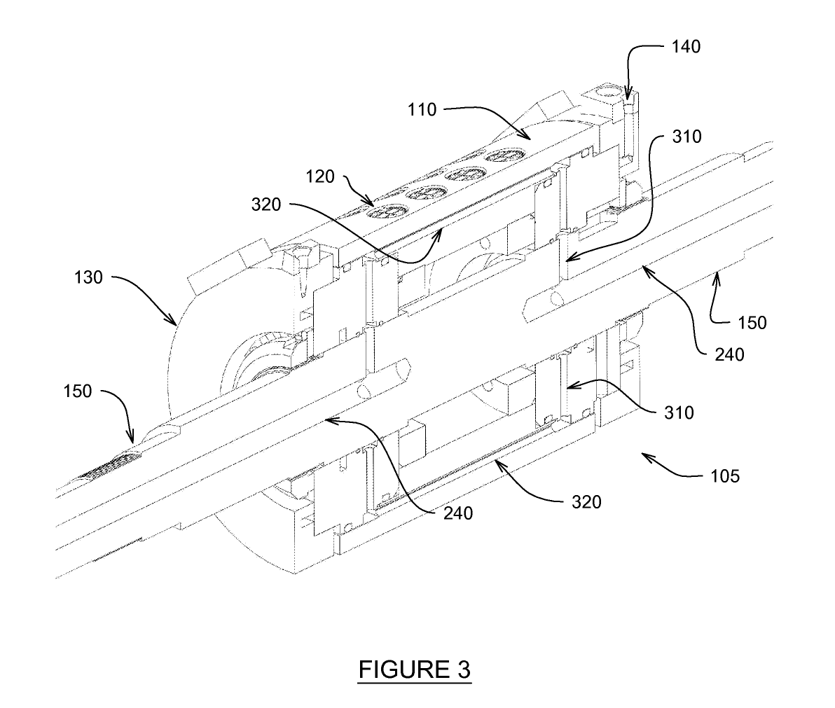

A temperature regulating fluid may be supplied to the rotary tool 100. In one example, the temperature regulating fluid may be supplied to the rotary tool 100 through the shaft 150. The temperature regulating fluid may be supplied through the shaft 150 at a selected shaft end (e.g., left side or right side), and may flow through a circulating channel (see FIG. 3), and then exit out and way from the rotary cylinder 105 at the opposite end of the shaft 150. In some variations, the temperature regulating fluid may enter and exit the same end of the shaft 150.

FIG. 3 is a cross section view, cut through the temperature control circuit. The temperature control circuit may include a source channel 240, a radiating channel 310, and a regulating channel 320. The source channel 240 may be located within the shaft 150. Temperature regulating fluid may enter the source channel 240 and then travel to the radiating channel 310 for delivery to the regulating channel 320. The regulating channel 320 may run at an appropriate depth beneath or between the mold cavities 120. The regulating channel may impart a desired temperature to one or more of the surface face 110, the rotary cylinder 105, and the mold cavities 120. The temperature may be optimized for product release from the mold cavities 120. For example, a cold temperature may cause the product to shrink away from the mold cavity 120 and release. A hot temperature may change the consistency of the product, encouraging release.

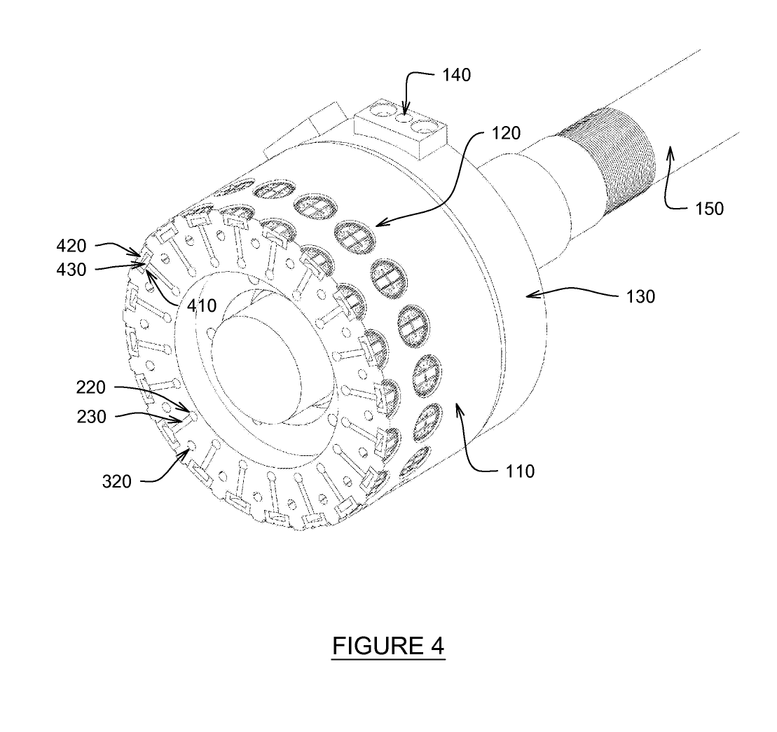

FIG. 4 provides a cross section view cut through a diameter of the rotary cylinder 105. The cross section bi-sects the mold cavities 120 and the orifice 230. Mold cavities 120 may be an assembly of a socket 410 and a mold tool insert 420. A mold tool insert 420 may have a mold tool insert surface. The mold tool insert 420 may be recessed relative to the surface face 110 of the rotary cylinder 105 such that the mold cavity 120 remains capable of receiving material (e.g., product dough) therein.

The mold tool insert 420 may be constructed of entirely of a porous material (as seen in FIG. 4) or partially of a porous material (e.g., as seen in FIG. 18 and otherwise herein). The porous materials are discussed in greater detail throughout the specification. The mold tool insert 420 may define an opening 430. The opening 430 may be defined by at least two surfaces of the mold tool insert 420, e.g., an outer facing wall and the side walls, which side walls are inserted into the socket 410.

The mold cavities 120 may be arranged in longitudinal rows along the surface face 110. The mold cavities 120 may be in fluid communication with orifices 230. The orifice 230 may be arranged in a radial formation relative to the shaft 150. The orifice 230 may be in fluid communication with the distribution channel 220. The distribution channel 220 may be in fluid communication with the source channel FIG. 2, 210. The distribution channel 220 and the regulating channels 320 may be arranged circumferentially around the inner region of the rotary cylinder 105. The distribution channels 220 and the regulating channels 320 may be off set from each other.

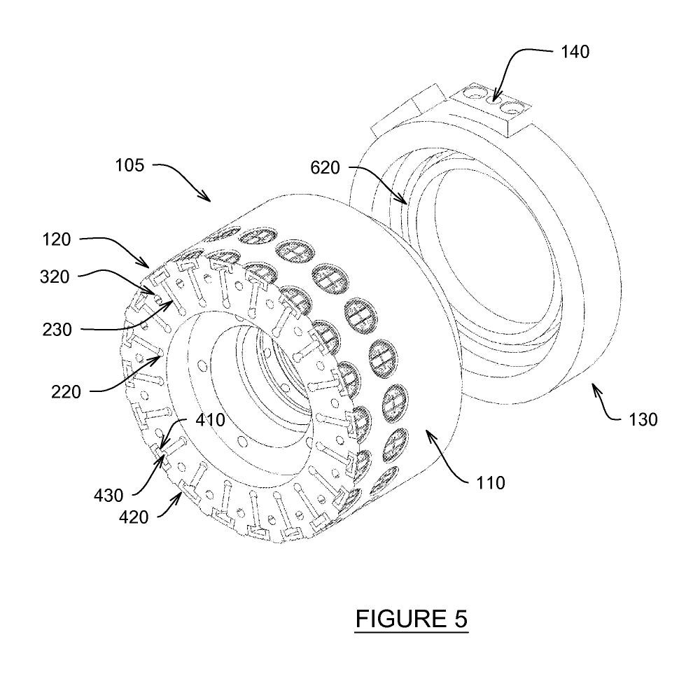

FIG. 5 is a cross section and partial view of a rotary cylinder 105 and an air supply hub 130. The air supply hub 130 may include a port 610 and a blast channel 620. The port 610 of the air supply hub 130 is capable of alignment with one distribution channel opening FIG. 18, 1830 of the rotary cylinder 105. This arrangement may allow air to be supplied to the distribution channels 220 of the rotary cylinder 105 in a row-by-row fashion, e.g., when the rotary cylinder revolves into alignment with the port 610, air will be delivered into the aligned distribution channel 220.

The blast channel 620 is capable of alignment with a plurality of distribution channel openings FIG. 17, 1710. In one variation, the blast channel 620 is capable of alignment with all of the distribution channel openings FIG. 17, 1710 of the rotary cylinder 105 that are not aligned with the port 610. For example, if “n” represents the total number of distribution channel openings FIG. 17, 1710, the blast channel 620 is capable of aligning with n−1 distribution channel openings FIG. 17, 1710. When air is supplied to all n of the distribution channel openings FIG. 17, 1710, then air will also travel all distribution channels 220 at once. Simultaneous air flow through all distribution channels 220 may have ejection advantages, e.g., of clearing material simultaneously from all mold cavities 120. Simultaneous air flow through all distribution channels 220 may have sanitary advantages, e.g., prohibiting cleaning solution from entering the air channels during wash down (described later herein).

FIG. 6 is a cross section of the air supply hub 130 assembled with a shaft 150. The air supply hub 130 has an inner face 630 and an outer face 635. The inner face 630 of the air supply hub 130 oriented to the first end 102 or the second end 107 of the rotary cylinder 105.

The air supply hub 130 may include a port 610. The port 610 of the air supply hub 130 may supply air to the distribution channel FIG. 5, 220 of the rotary cylinder 105. The configuration of the port 610 may permit controlled air release into the distribution channel FIG. 5, 220, which may further permit controlled product release from the mold cavities 120.

In a variation, air is supplied to the port 610 of the air supply hub 130, e.g., through an air port 140. As the rotary cylinder 105 rotates relative to the air supply hub 130 (which may be stationary), the distribution channel opening FIG. 17, 1710 and thus distribution channel 220 in the rotary cylinder 105 may rotate into alignment with the port 610 of the air supply hub 130. When a port 610 is in alignment with the distribution channel opening FIG. 17, 1710 and thus distribution channel 220, air is supplied to distribution channel 220. The air supplied to the distribution channel 220 passes through the orifices 230 and exits through the mold cavity 120. As the rotary cylinder 105 rotates relative to the air supply hub 130, the distribution channel openings FIG. 17, 1710 rotate out of alignment with the ports 610 on the air supply hub 130. When the distribution channel openings FIG. 17, 1710 rotate out of alignment with the port 610 of the air supply hub 130, air flow to the distribution channels 220 ceases. Thus, product in the mold cavity 120 is not ejected.

The air supply hub 130 may include a blast channel 620. The blast channel 620 may run the circumference of the air supply hub 130. The blast channel 620 may be aligned with the distribution channel openings FIG. 17, 1710 of the rotary cylinder 105 as described above (e.g., n−1 distribution channel openings FIG. 17, 1710). Air is supplied to the blast channel 620 of the air supply hub 130, e.g., through an air port 180.

Good manufacturing practices prescribe regular wash down cleaning of food production tooling. During a wash down, air may be supplied to all distribution channels 220 at once via a combination of the blast channel 620 and the port 610. The air supplied to the distribution channels 220 may simultaneously eject from all mold cavities 120. The simultaneous ejection of air may prevent water migration into the orifices 230 and channels 220, 210 during wash down. Alternatively or additionally, the orifices 230 and channels 220, 210, may be cleaned by a supply of washdown fluid supplied through the source channel 210, the distribution channel 220, and/or the orifices 230.

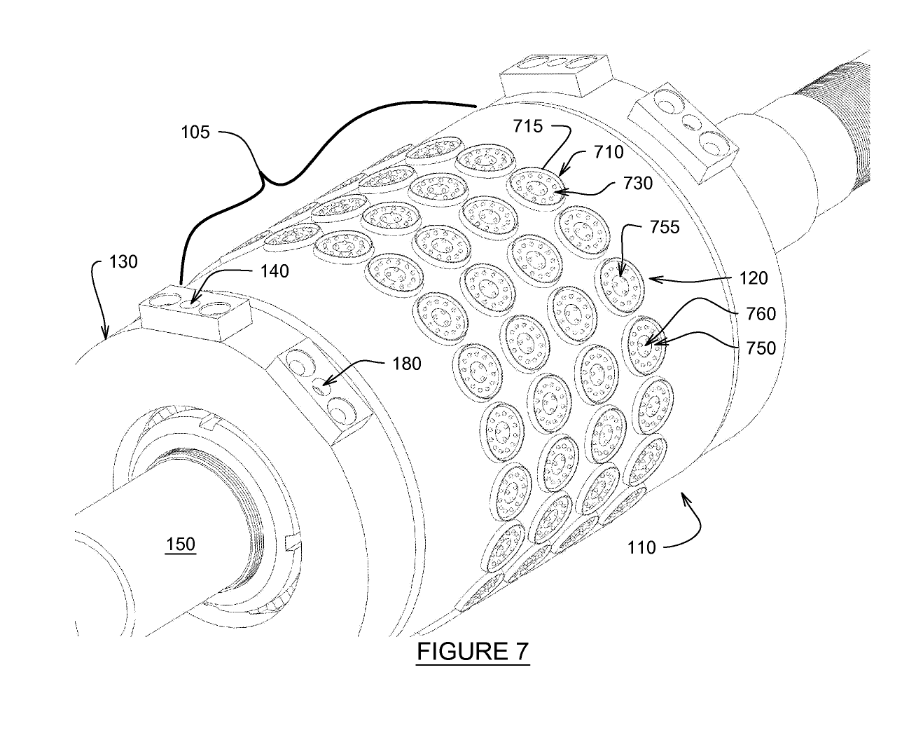

FIG. 7 provides an example of how the ejection technology may be applied to a rotary cutter. The concepts introduced above for the rotary molder may be applied to the cutter and are incorporated herein in their entirety.

FIG. 7. A rotary tool may include a rotary cylinder 105, air supply hub 130 and a shaft 150. The rotary cylinder 105 and the air supply hub 130 may be assembled on the shaft 150. The shaft 150 may adapt the rotary tool 100 to placement into any rotary manufacturing system.

The rotary cylinder 105 may include a surface face 110. The surface face 110 may be the exterior portion of the rotary tool 100. The surface face 110 may be the portion of the rotary tool 100 capable of contacting a manufacturing raw material, e.g., product dough. The surface face 110 may include a cutter cavity 710. The cutter cavities 710 are shown in sets of four; however, the rotary tool 100 may include fewer or more mold cavities 120 per set. Additional or alternative arrangements may include offset pitching and nesting of cutter cavities 710, among others. Other arrangements are also possible.

A rotary tool 100 may include an air ejection technology. The rotary tool 100 may include an internal manifold for circulating air (shown in subsequent figures). The rotary tool 100 may include one or more air supply hub 130. In the example of FIG. 7, the rotary tool 100 is assembled with two air supply hubs 130. The air supply hubs 130 may be arranged in a book-end type arrangement with the rotary cylinder. The air supply hub 130 may include one or more air ports 140, 180. The air ports 140, 180 may be points of air entry and/or air exit.

The cutter cavities 710 may have raised cutter portions that raise above the plane of the surface face 110, a lowered cavity portions that are below or continuous with the surface face 110. The cutter cavities 710 may include a cutter side wall 715 and plugs 760. The plugs 760 may include docker pins 730 as shown, or may not include docker pins 730. The side walls 715 may rise out of the plane of the surface face 110 such that the side walls 715 permit the rotary tool 100 to perform a cutting function. The plugs 760 may be made of a porous material. In a variation, the entire cutter cavity 710 may be made of a porous material.

The cutter cavity 710 has a side wall 715 that is raised above the plane of the surface face 110 and a bottom wall 750 that is below the surface face 110 or continuous with the surface face 110. The bottom wall 750 includes a socket 755 (which is configured as is socket 410 of FIG. 4), which in this figure are shown assembled with a plug 760. The cutter cavity 710 also includes docker pins 730, both on the plug 760 and otherwise arranged on the bottom wall 750. Docker pins 730 are placed such that they can punch holes into a product dough. The holes allow steam to escape during baking, thus helping to prevent the food stuff from over-inflating. In addition, the holes made by docker pins may connect the dough layers (e.g., or dough sheets), thereby controlling puffing and size of the product. With a cavity tool, docker pins can assist with the release of molded product, e.g., by holding the product in the cavity. Docker pins 730 may have a height higher than, e.g., the side wall 715 of the cutter cavity 710 or mold cavity 120.

With some food stuffs, for example but not limited to, cracker dough, there is a desire that the dough never touch the bottom wall 750 of the cutter cavity 710. In some situations, if the dough reaches the bottom wall 750 of the cutter cavity 710, the dough may stick and lift, which leads to tearing.

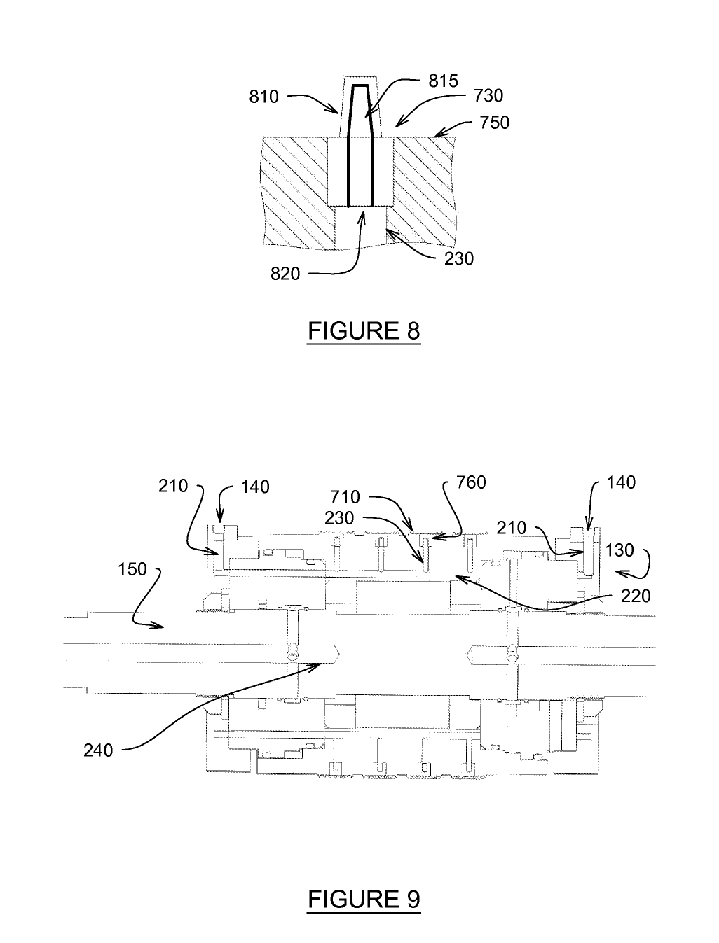

FIG. 8 is an enlarged view of a docker pin 730 portion of a plug 760. The docker pin 730 includes an angled spike 810 and a base 820. The angled spike 810 has a diameter that increases from the outermost portion of the angled spike 810 (e.g., furthest from the surface face 110) to where it joins the base 820. The angled spike 810 has a hollow opening 815 therein. The walls of the angled spike 810 may have a substantially constant thickness. The angled spike 810 may be constructed of porous material as disclosed herein. The base 820 of the docker pin 730 may also be constructed of porous material. The base 820 of the docker pin 730 may be unified with the angled spike 810, or may be a multi-piece construction. The hollow opening 815 may reduce the air resistance of the angled spike 810 over the resistance the air would encounter if the spike was made of a solid porous material. Airflow traveling from the orifice 230 and through the docker pin 730 may assist the ejection efficiency of the food stuff contacted by the cutter cavity 710. Ejection air may exit the docker pin 730 where the base 820 forms a continuous face at the surface face 110 and through the exterior diameter of the angled spike 810 of the docker pin 730.

The porous material may be sized by, for example but not limited to, electric discharge machining, to a precision size and shape for press fitting into the socket 755. Docker pins 730 of many sizes and lengths are used in rotary tool design. Size is determined by the specific needs, both technical and aesthetic.

The plug 760 may be precision machine shaped material. The plug 760 may be dimensioned to press fit into the socket 755 such that the exterior portion of the plug 760 is continuous with the bottom wall of the mold cavity 120 and/or cutter cavity 710.

If the mold cavity 120 and/or cutter cavity 710 includes a design contour the plug 760 may be placed in a portion of the mold cavity 120 or cutter cavity 710 that has no design etching. Alternatively or additionally, if the mold cavity 120 and/or cutter cavity 710 includes a design contour the exterior face of the plug 760 may also have a design contour that is continuous with the design contour of the cavity, such that there is no interruption in the pattern. Alternatively or additionally, the mold cavity 120 and/or cutter cavity 710 may include no design contour, and the exterior surface of the plug 760 may have a design contour, such that, when integrated with the mold cavity 120 and/or cutter cavity 710 and contacted with food stuff, the plug 760 imparts a design to the food stuff.

FIG. 9 provides a cross-section view of the rotary tool of FIG. 7, cut through the plane of channels 210 and 220 and orifice 230. Ejection air may be supplied through an air manifold. The air manifold may be positioned within an air supply hub 130. In one example, ejection air may be supplied through air supply hub 130 existing on each side of the rotary cylinder 105.

The rotary tool may include one or more channels. The one or more channels may accommodate the circulation of ejection air, temperature regulating fluid, or otherwise, e.g., through the rotary cylinder 105. FIG. 9 provides a cross section of an exemplary air channel. In this figure, a source channel 210 provides ejection air to a distribution channel 220 shown as a longitudinal channel parallel with a row of cutter cavities 710. Each cutter cavity 710 is in fluid communication with the distribution channel 220, e.g., through an orifice 230.

Air may flow to the orifice 230 through the air supply hub 130. Supply of air from the air supply hubs 130 may be selective, e.g., may be subject to regulation. In one example, supply of air from the air supply hub 130 may be supplied in a periodic pattern, e.g., corresponding to a preferred product ejection position of the die roll. The air supply hub 130 may supply air to distribution channels 220. The distribution channels 220 may run parallel to the shaft 150. The distribution channels 220 may supply air to the orifices 230, e.g., creating an ejection force on material contact by a region of the cutter cavity 710. The mold cavity 120 and/or cutter cavity 710 may be constructed of a combination of solid material (non-porous material) and porous material. Solid material (non-porous material) may be resistant to the flow of air. Porous material may be permissive to air flow. Porous material may, additionally or alternatively, be resistant to back flow of solid materials and/or liquids (but not gases). The number and arrangement of channels may be design dependent. The air supply hubs 130 may supply air on a row by row basis.

In one variation, the air supply hub 130 may be stationary relative to the rotary cylinder 105. As the rotary cylinder 105 rotates relative to the air supply hubs 130, each row of mold cavities 120 may receive a pulse of ejection air. The pulse of ejection air may be timed with the timing of other elements of the system, e.g., conveyor systems. Timing of the air ejection may be set by the selective positioning of the air supply hubs 130 relative to the distribution channel 220. The air supply hubs 130 may be constructed of a bearing type material such as PTFE (Teflon) to permit sliding and sealing on the end surfaces of the rotary cylinder 105, and/or on the air supply hubs 130.

FIG. 9 provides a cross section of an exemplary temperature control channel. The temperature control circuit may include a source channel 240. The source channel 240 may be located within the shaft 150. The temperature control circuit may circulate a fluid, for example a fluid capable of being heated or cooled. The fluid may have the property of heating and/or cooling the surface of the rotary tool 100. The fluid may have the property of maintaining a temperature of the rotary tool 100. The heating, cooling, and/or maintenance of a temperature may optimize ejection from the cutter cavities 710.

A temperature regulating fluid may be supplied to the rotary tool 100. In one example, the temperature regulating fluid may be supplied to the rotary tool 100 through the shaft 150. The temperature regulating fluid may be supplied through the shaft 150 at a selected shaft end (e.g., left side or right side), and may flow through a circulating channel, and then exit out and way from the rotary cylinder 105 at the opposite end of the shaft 150. In some variations, the temperature regulating fluid may enter and exit the same end of the shaft 150.

Rotary tools may be mounted in any commercial rotary machine, including single roll and dual roll machines. The rotary cutter may use either molds or cutters. The molds and cutters may be continuous with the surface face 110. The molds may be above the plane of the surface face 110 of the rotary cylinder 105 or below the plane of the surface face 110 of the rotary cylinder 105. Similarly, cutter cavities 710 may have portions that rise above the surface face 110 of the rotary cylinder 105. The cutter cavities 710 may also have portions that are located below the surface face 110 of the rotary cylinder 105 (e.g., by machining or otherwise as described herein). The location of an orifice 230 is not limited to a center location within the mold cavity 120 and/or cutter cavity 710. There may be more that one orifice 230 in a mold cavity 120 and/or cutter cavity 710. The mold cavity 120 and/or cutter cavity 710 may have various shapes and sizes. The ejection technology may substantially improve tool performance and thereby increase efficiency and decrease cost, e.g., by reducing down time and maintenance. The ejection technology may further permit formulation changes such as reduced fat, without losing ejection integrity. The ejection technology may also increase the range of possible shapes and sizes of product without impact on tool performance.

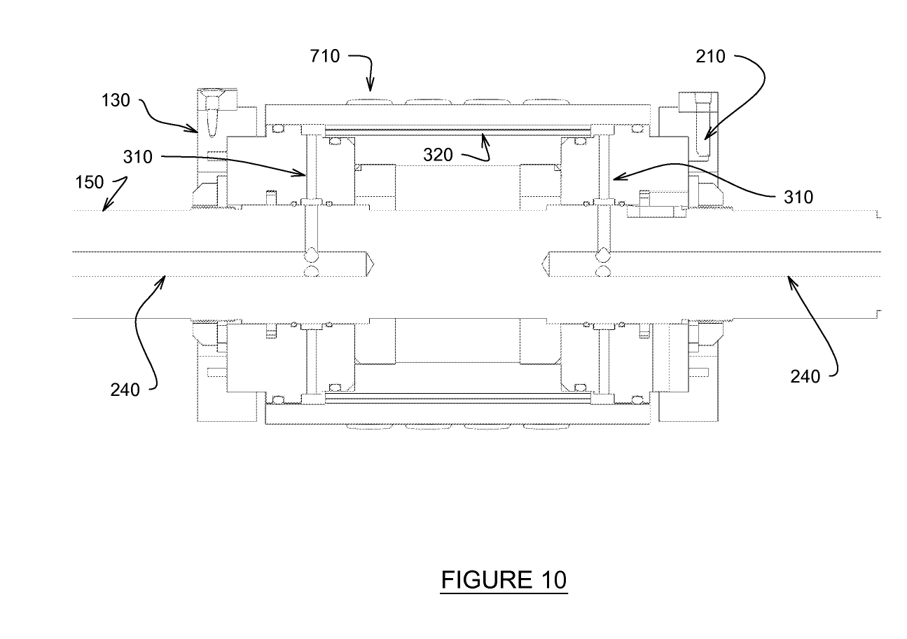

FIG. 10 is a cross section view, cut through the temperature control circuit. The temperature control circuit may include a source channel 240, a radiating channel 310, and a regulating channel 320. The source channel 240 may be located within the shaft 150. Temperature regulating fluid may enter the source channel 240 and then travel to the radiating channel 310 for delivery to the regulating channel 320. The regulating channel 320 may run at an appropriate depth beneath or between the cutter cavities 710. The regulating channel 320 may impart or maintain a desired temperature to the surface face 110, the rotary cylinder 105, the cutter cavities 710 or both. The temperature may be optimized for product release from the cutter cavities 710. For example, a cold temperature may cause the product to shrink away from the cutter cavity 710 and release. A hot temperature may change the consistency of the product, encouraging release.

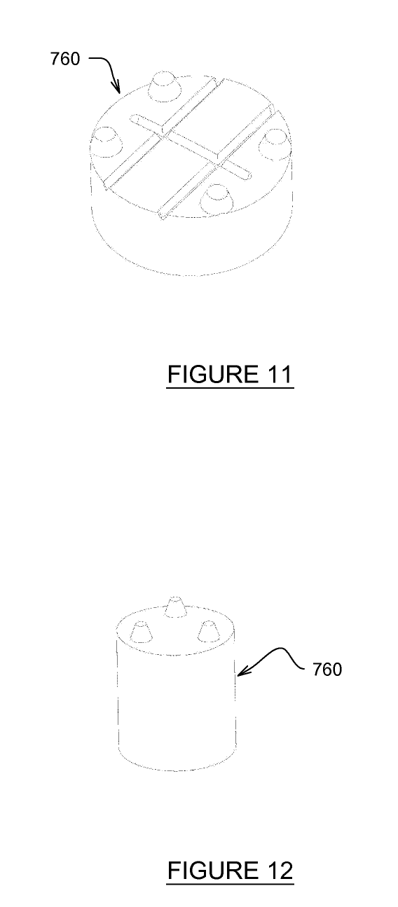

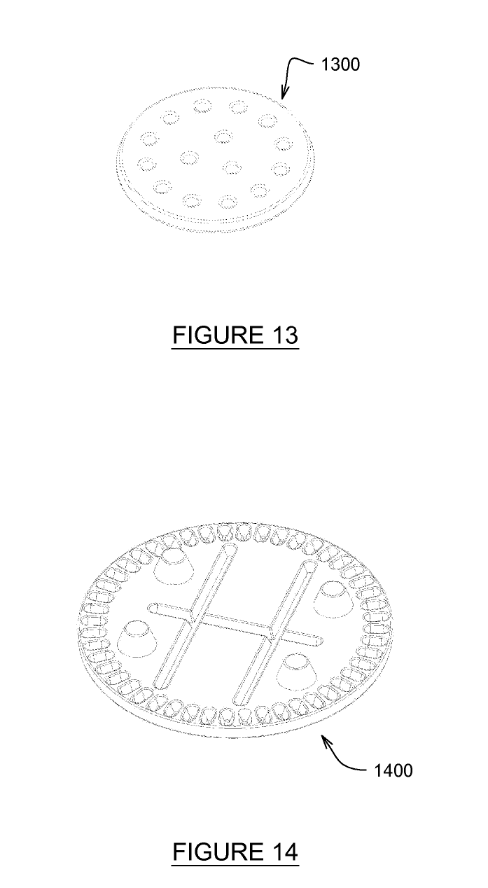

FIGS. 4-6 are applicable to the rotary tool 100 of FIG. 7. The difference being the form of the cavity, e.g., the mold cavity 120 may be replaced out with the cutter cavity 710. Similarly, the plug 760 is a characteristic of the mold cavity 120, in a manner similar to that of FIGS. 7 and 8. FIG. 11 is a view of a plug 760 of porous material that may be incorporated into the mold cavity 120 of FIG. 1 et seq. The plug 760 may have a hollow interior permitting optimized air flow from the orifice 230. FIG. 12 is a view of a plug 760 of porous material that may be incorporated with the cutter cavity 710. The plug 760 may have a hollow interior permitting optimized channeling of air from the orifice 230. FIG. 13 is an example of a consumable 1300 that might be ejected from the cutter cavity 710. Here one can view the surface detail of the consumable imparted by the cutter cavity 710, including the contour of the plug 760. FIG. 14 is an example of a consumable 1400 that might be ejected from a mold cavity 120 incorporating the plug 760 of FIG. 11. A surface detail may be imparted by a contour of the mold cavity 120, including a contour of the plug FIG. 11, 760.

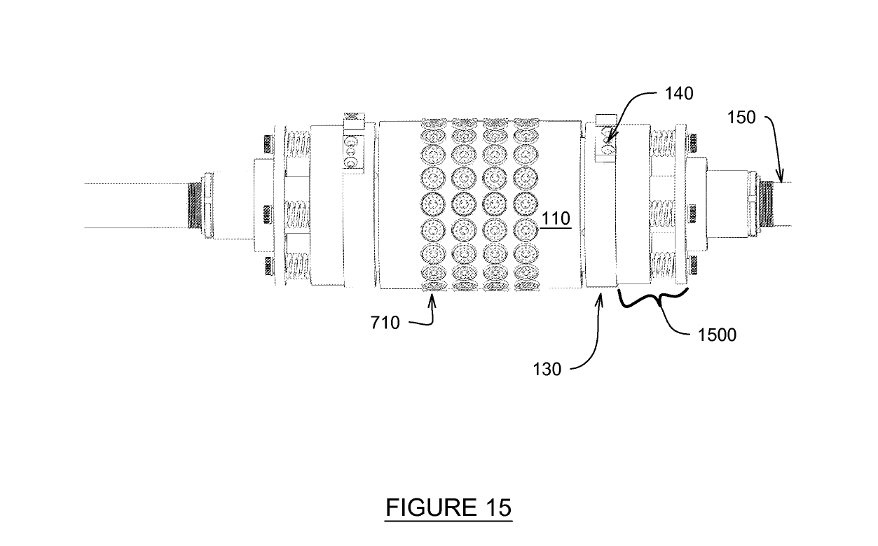

FIG. 15 is a variation of a rotary cylinder 105 assembled with spring pack assembly 1500 at each end. The air supply hub 130 may be loaded axially onto the ends of the rotary cylinder 105 and maintain an air seal therewith. Loading may be provided by a spring pack assembly 1500. The spring pack assembly 1500 may apply a force, e.g., on the air supply hub 130 which may maintain a contact seal between the air supply hub 130 and the rotary cylinder 105. While a spring pack assembly 1500 is shown, the spring pack design may be replaced by any pressure pack capable of providing a force, e.g., an air cylinder may provide the necessary force needed for sealing contact.

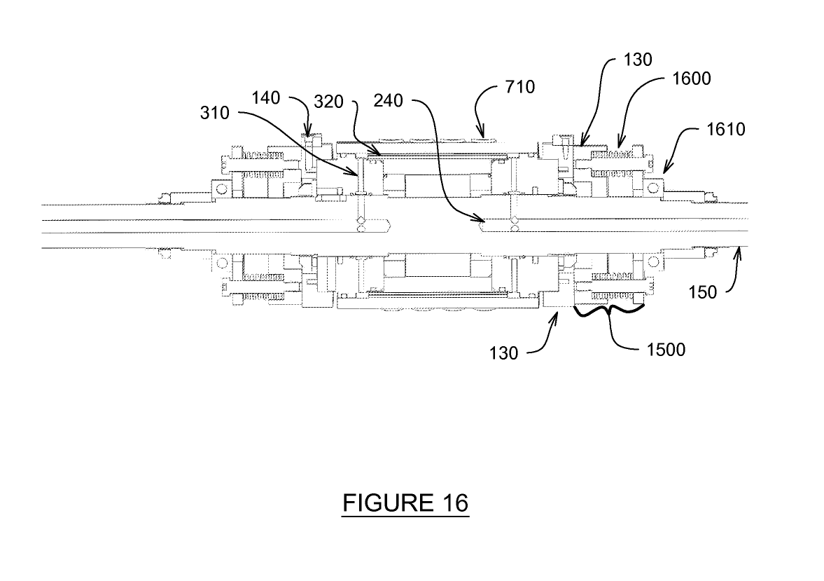

FIG. 16 is a sectional view cut through a plane that passes through the center of the spring pack assembly 1500. The spring pack assembly 1500 may be positioned concentrically around the shaft 150. The spring pack assembly 1500 may apply a force on the air supply hub 130 and the roller bearing 1610. The roller bearing 1610 may allow the spring pack assembly 1500 to remain in contact (e.g., stationary contact) with the air supply hub 130 while the rotary cylinder 105 rotates with the shaft 150. In one variation, only the side of the air supply hub 130 that is directly in contact with the end of the rotary cylinder 105 has a sliding motion. The sliding motion may produce a tangential force which must be matched and applied to the air supply hub 130 for the air supply hub 130 to maintain a stationary position. In a variation, the rotary cylinder 105 and the shaft 150 may rotate together while the spring pack assembly 1500 and the air supply hubs 130 remain stationary. The face of the air supply hub 130 closes to the rotary cylinder 105 may abut the rotary cylinder 105 and may be in sealed sliding contact with the rotary cylinder 105.

FIG. 17 provides an exploded assembly view of a variation of the system. While the cutter system 1700 is shown, the figure equally applies to the molder system.

FIG. 18 provides a variation of the rotary tool. A rotary tool may be multi-functional. In a variation, the system is provided with a rotary cylinder 105. The concepts introduced above in FIGS. 1-17 are incorporated herein in their entirety.

A rotary tool 100 may include a rotary cylinder 105, air supply hub 130 and a shaft 150. The rotary cylinder 105 and the air supply hub 130 may be assembled on the shaft 150. The shaft 150 may adapt the rotary tool 100 to placement into any rotary manufacturing system.

The rotary cylinder 105 may include a surface face 110. The surface face 110 may be the exterior portion of the rotary tool 100. The surface face 110 may include a socket 1810. The sockets 1810 are shown in sets of four, however, the rotary tool 100 may include fewer or more sockets 1810 per set. Additional or alternative arrangements may include offset pitching and nesting of sockets 1810, among others. Other arrangements are also possible.

A rotary tool 100 may include an air ejection technology. The rotary tool 100 may include an internal manifold for circulating air (shown in subsequent figures). The rotary tool 100 may include one or more air supply hub 130. In the example of FIG. 18, the rotary cylinder 105 is assembled with two air supply hub 130. The air supply hub 130 may be arranged in a book-end type arrangement with the rotary cylinder 105. The air supply hub 130 may include one or more air ports 140, 180. The air ports 140, 180 may be points of air entry and/or air exit. The temperature regulating channel opening 1840 may be points of temperature regulating fluid entry and/or exit.

The sockets 1810 may receive tool inserts 1820, which may be cutter inserts (shown). The socket 1810 and tool insert 1820 system may permit easy replacement of damaged tools and/or easy adaptation of the rotary tool to various different designs of tool inserts 1820, e.g., changeover to varying product design styles for producing consumables. The easy replacement minimizes the interruption of the production process in both down time and cost.

The tool inserts 1820 may include plugs 760. The plugs 760 may include docker pins 730 as shown, or may not include docker pins 730. The plugs 760 may be made of a porous material described elsewhere herein.

It should be understood that in all variations, the porous material may be a micro-drilled material. The plug 760 may be precision machine shaped material. The plug 760 may be dimensioned to fit into a receiving recess of the tool inserts 1820 such that the exterior portion of the plug 760 is continuous with, in the case of a cutter design, the surface face 110 of the rotary cylinder 105.

If the tool insert 1820 includes a design contour the plug 760 may be placed in a portion of the tool insert 1820 that has no design etching. Alternatively or additionally, if the tool insert 1820 includes a design contour the exterior face of the plug 760 may also have a design contour that is continuous with the design contour of the cavity, such that there is no interruption in the pattern. Alternatively or additionally, the tool insert 1820 may include no design contour, and the exterior surface of the plug 760 may have a design contour, such that, when integrated with the tool insert 1820 and contacted with food stuff, the plug 760 imparts a design to the food stuff.

Ejection air may be supplied through an air manifold. The air manifold may be positioned within an air supply hub 130. In one example, ejection air may be supplied through air supply hub 130 existing on each side of the rotary cylinder 105.

The rotary tool 100 may include one or more channels.

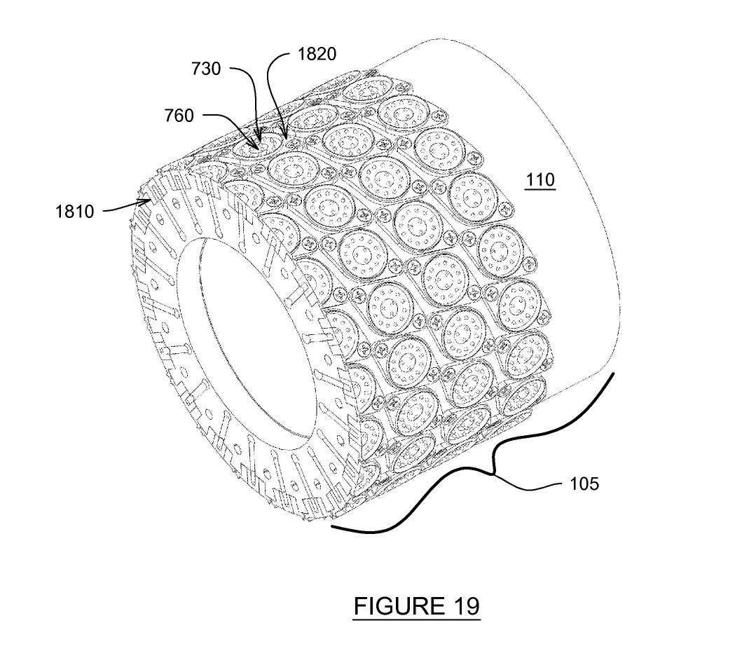

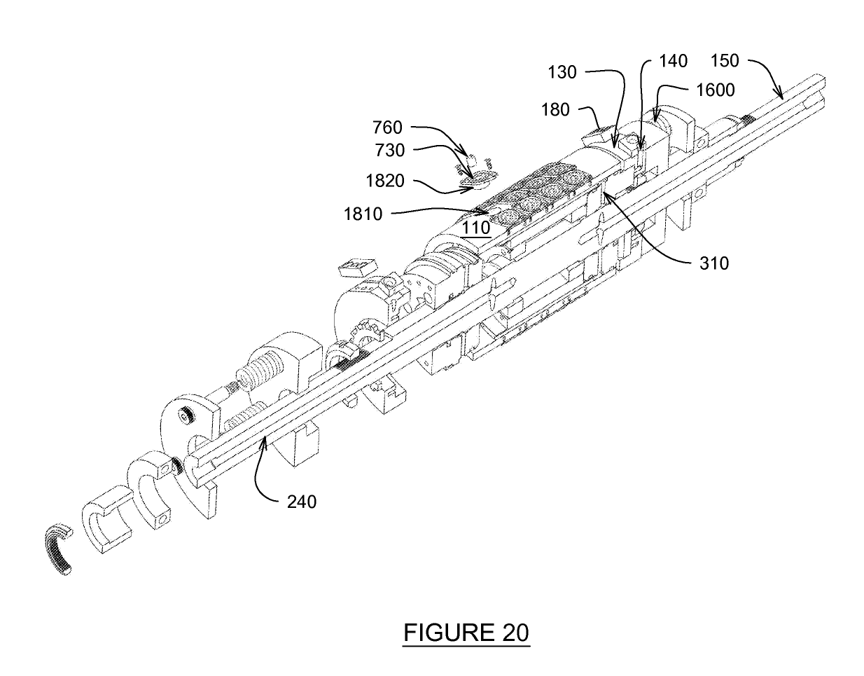

FIG. 19 provides a section view of the rotary tool implementing socket assembly. FIG. 20 provides an exploded assembly view of the rotary tool implementing socket socket 1810 and tool inserts 1820.

The component parts of the socket assembly may be identical to the parts illustrated elsewhere herein, except for the socket 1810 and tool inserts 1820.

In one variation, the porous material may be a porous metal material that has inter-connected porosity. A porous metal material may be fabricated from metal powder particles using powder metallurgy techniques. The porous material may have a range of pore sizes from about 0.5 micrometer to about 200 micrometers. The porous material may comprise synthetic materials, ceramics, or combinations and composites thereof. The porous material may be a sintered material or may be a micro-drilled material. The pore size (whether created by a sintering process or by micro-drilling) may range from 0.2 to 100 micrometers. A porous structure may have the advantage of preventing the dough product from being caught or trapped in the mold cavity or cutter cavity.

While variations of the invention have been described, it will be apparent to those of skill in the art that many more implementations are possible that are within the scope of the claims.

1. A rotary tool comprising:
a rotary cylinder;
the rotary cylinder comprising;
a surface face;
a first end; and
a second end;
the surface face having a plurality of cavities, the cavities having a porous insert;
the cavities each in fluid communication with a distribution channel;
the distribution channel passing longitudinally through the rotary cylinder and the distribution channel terminating at a distribution channel opening on at least one of the first end and the second end of the rotary cylinder;
an air supply hub adjacent to the rotary cylinder;
the air supply hub having an inner face and an outer face;
the inner face of the air supply hub oriented to at least one of the first end or the second end of the rotary cylinder;
the inner face of the air supply hub defining a port; and
the port capable of alignment with a distribution channel opening of the rotary cylinder.

2. The rotary tool of claim 1, the air supply hub further comprising:
the inner face of the air supply hub defining a blast channel; and
the blast channel capable of alignment with n−1 distribution channel openings of the rotary cylinder

3. The rotary tool of claim 1, further comprising:
the cavities are mold cavities.

4. The rotary tool of claim 1, further comprising:
the cavities are cutter cavities.

5. The rotary tool of claim 1, the porous insert comprising a plug situated in a bottom wall of the cavity.

6. The rotary tool of claim 1, further comprising a temperature control circuit.

7. The rotary tool of claim 1 further comprising, the air supply hub assembled with a spring pack assembly, the spring pack assembly positioned concentrically around the central shaft.

8. The rotary tool of claim 1 further comprising: the rotary mold cylinder assembled with a central shaft;
the central shaft defining a source channel there through;
the rotary mold cylinder further comprising a plurality of regulating channels; and
the regulating channels of the rotary mold cylinder in fluid communication with the source channel.

9. A rotary tool comprising:
a rotary cylinder;
the rotary cylinder comprising;
a surface face;
a first end; and
a second end;
the surface face having a plurality of sockets, the sockets capable of receiving a tool insert;
the sockets each in fluid communication with a distribution channel;
the distribution channel passing longitudinally through the rotary cylinder and the distribution channel terminating at a distribution channel opening on at least one of the first end and the second end of the rotary cylinder;
an air supply hub adjacent to the rotary cylinder;
the air supply hub having an inner face and an outer face;
the inner face of the air supply hub oriented to at least one of the first end or the second end of the rotary cylinder;
the inner face of the air supply hub defining a port; and
the port capable of alignment with a distribution channel opening of the rotary cylinder.

10. The rotary tool of claim 9, the air supply further comprising:
the inner face of the air supply hub also defining a blast channel; and
the blast channel capable of alignment with n−1 distribution channel openings of the rotary cylinder.

11. The rotary tool of claim 9, the tool insert composed of a porous material having a pore size of about 0.5 micrometer to about 200 micrometers.

12. The rotary tool of claim 9, the tool insert further comprising a surface and side walls defining a hollow opening.

13. The rotary tool of claim 9, the tool insert composed of a non-porous material; the tool insert defining a recessed opening in an outer surface; the recessed opening capable of receiving a plug; and the plug composed of a porous material.

14. The rotary tool of claim 9, the tool insert comprising a cutter.

15. The rotary tool of claim 13, the tool insert composed of a porous metal material having a pore size of about 0.5 micrometer to about 200 micrometers.

16. The rotary tool of claim 13, the tool insert composed of a non-porous material; the tool insert defining a recessed opening in an outer face; the recessed opening capable of receiving a plug; the plug composed of a porous material.

17. The rotary tool of claim 13, wherein the plug comprises a docker pin plug, the docker pin plug comprising a base and a spike.

18. The rotary tool of claim 9, the rotary mold cylinder assembled with a central shaft;
the central shaft defining a source channel there through;
the rotary mold cylinder further comprising a plurality of regulating channels; and
the regulating channels of the rotary mold cylinder in fluid communication with the source channel.

19. The rotary tool of claim 9, further comprising, the air supply hub assembled with a spring pack assembly, and the spring pack assembly positioned concentrically around the central shaft.
